(19) United States
(12) Patent Application Publication
(10) Pub. No.: US 2016/0098007 A1
(43) Pub. Date: Apr. 7, 2016

(54) IMAGE FORMING APPARATUS

(71) Applicant: CANON KABUSHIKI KAISHA, Tokyo (JP)

(72) Inventors: Shigeo Doi, Toride-shi (JP); Tadahisa Sugiyama, Matsudo-shi (JP)

(21) Appl. No.: 14/867,249

(22) Filed: Sep. 28, 2015

(30) Foreign Application Priority Data
Oct. 2, 2014 (JP) 2014-203685

(51) Int. Cl. G03G 21/16

(52) U.S. Cl. CPC G03G 21/1633

(57) ABSTRACT

A door is held in an open condition by locking a stopper member whose one end is turnably supported by an apparatus body. The stopper member is composed of a base member having a project portion and a turning shaft portion supported by a printer body, and a reinforcing member. The reinforcing member is joined with the base member by a joining mechanism such that, in a case when a force of predetermined magnitude is applied to the door in opening the door, the base member is broken and the reinforcing member holds the door by supporting the project portion and the turning shaft portion of the broken base member.

### BACKGROUND OF THE INVENTION

1. Field of the Invention

The present invention relates to an image forming apparatus including an openable door.

2. Description of the Related Art

Hitherto, an image forming apparatus such as a printer is provided with an openable door on a side surface of an apparatus body such that the door can be opened in taking a jammed sheet or in maintaining the apparatus. Here, the door is generally configured such that the door moves to an open position by its own weight when a user leaves his/her hands from the door on a way of opening the door so that the door does not stop at a mid-position between a close position and the open position.

By the way, when the door moves to the open position as the user leaves his/her hands from the door, a large impact force is generated on the door and the image forming apparatus body. Then, conventionally, an oil damper is provided in an opening/closing mechanism of a cover of the image forming apparatus as an impact relieving portion for relieving such impact by reducing moving speed of the door in an opening direction as disclosed in Japanese Patent Application Laid-open Nos. 2006-83551 and 2007-279274. Still further, there is one provided with a spring to bias the door in a closing direction to restrict the moving speed of the door in the opening direction as disclosed in Japanese Patent Application Laid-open Nos. 2003-241466 and 2009-134227 for example.

Here, in relieving the impact generated in opening the door by using the impact relieving portion, it is necessary to set braking force of the impact relieving portion reducing the moving speed of the door in the opening direction while assuming a maximum value of the impact force generated in opening the door. Here, if the impact relieving portion is used, it is necessary to assess a maximum value of operation force applied by the user in opening the door and others and to balance various kinds of aspects such as compatibility of the impact relieving portion and the operation force of the user, cost performance of the configuration of the impact relieving portion, and others.

However, the image forming apparatus is restricted variously due to its entire configuration in reality, and there are various problems in setting the configuration and the braking force of the impact relieving portion. If a rotary damper is used as the impact relieving portion for example, it is necessary to configure such that a force of opening the door generated by own weight of the door itself exceeds a restricting force of the rotary damper within a range in which the rotary damper effectively functions within an opening/closing operational area of the door.

In this case, force generated when the user vigorously opens the door wholly becomes impact force. That is, it is important to assume how much the user applies force to the door in setting a rotational load of the oil damper. If the force applied to the door is underestimated here and if force greater than the estimation is applied to the door, not only the door itself or components related to the door but also the body of the image forming apparatus and a frame composing the frame body in particular are possibly damaged. In contrary, if the force applied to the door is overestimated, it may become difficult to move the door to the open position by own weight of the door itself, and hence operability thereof drops.

Meanwhile, in the case of the configuration of using the spring as the impact relieving portion and of relieving the impact in opening the door by applying resistance in the opening direction of the door, the same problems with those when the rotary damper is used are assumed to occur in setting strength of spring force. Still further, because the force is applied in a direction of closing the door when the spring is used, and the spring bias force is added to the operation force of the user in closing the door, speed of the door is accelerated as the door comes closer to the close position. Therefore, it is also necessary to consider the relief of the impact in closing the door.

### SUMMARY OF THE INVENTION

According to one aspect of the invention, an image forming apparatus includes an apparatus body, a door openably supported by the apparatus body, an arm portion whose one end is supported by the apparatus body and locking and holding the door in an open condition. The arm portion includes a body portion including a first engage portion engaging with the door and a second engage portion engaging with the apparatus body, and a reinforcing member locking the door when the body portion is broken by force applied to the door in opening the door.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a full-color laser printer, i.e., one exemplary image forming apparatus, according to an embodiment of the invention.

FIG. 2 is a perspective view of a door of the laser printer.

FIG. 3 illustrates a rail member provided on the door.

FIG. 4 illustrates a stopper member provided on a printer body of the laser printer.

FIG. 5A illustrates a state in which the door is closed.

FIG. 5B illustrates a state when the door is opened when jamming has occurred.

FIG. 5C illustrates a state when the door is opened for maintenance.

FIG. 6 illustrates a rotary damper provided in the laser printer.

FIG. 7A is a perspective view illustrating a configuration of the stopper member.

FIG. 7B is a perspective view of the stopper member viewed from a direction different from a direction of FIG. 7A.

FIG. 8 is a section view illustrating the configuration of the stopper member.

FIG. 9A is a partial section view illustrating a joining portion joining a base member with a reinforcing member of the stopper member by a screw.

FIG. 9B illustrates a relationship between the reinforcing member and the screw in a state in which the base member is not deformed.

FIG. 10 illustrates a state in which the base member of the stopper member is broken.

FIG. 11A illustrates the relationship between the screw and the reinforcing member before the base member of the stopper member is broken.

FIG. 11B illustrates the relationship between the screw and the reinforcing member after the base member of the stopper member is broken.

FIG. 12A illustrates another configuration of the stopper member in which a gap is provided between a second insertion hole and a second screw.

FIG. 12B illustrates another configuration of the stopper member in which a gap is provided between a first insertion hole and a first screw and between the second insertion hole and the second screw.

### DESCRIPTION OF THE EMBODIMENTS

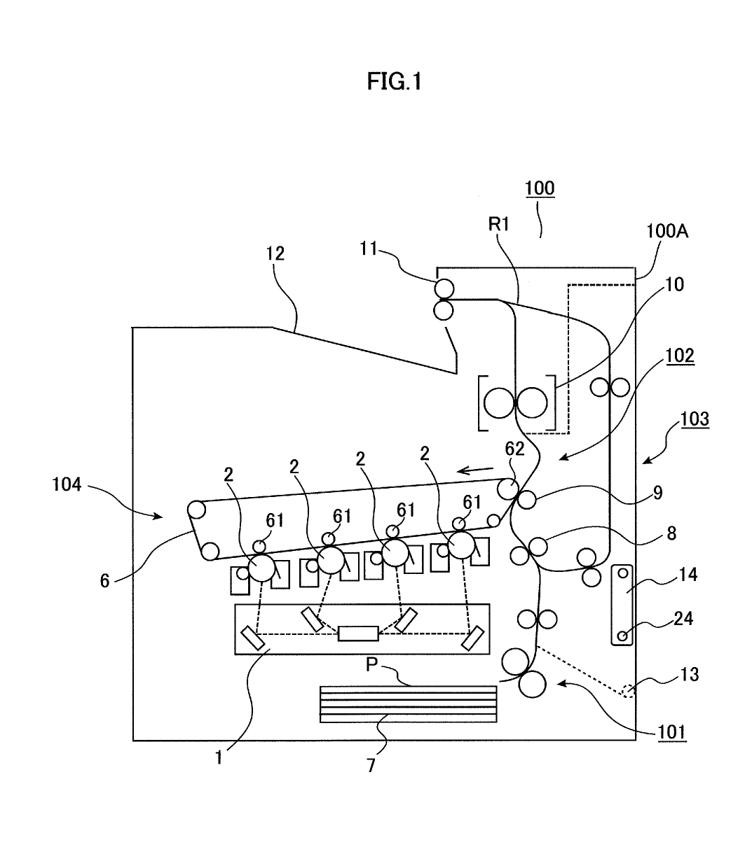

An embodiment of the invention will be described in detail with reference to the drawings. FIG. 1 is a schematic diagram illustrating a configuration of a laser printer, i.e., one exemplary image forming apparatus according to the embodiment of the invention. The laser printer 100 (referred to simply as a ‘printer’ hereinafter) includes a printer body 100A. The printer body 100A includes an image forming portion 102 forming an image on a sheet P, a sheet feeding portion 101 feeding the sheet P from a sheet feed cassette 7, and others.

The image forming portion 102 includes a scanner unit 1, photosensitive drums 2, and an intermediate transfer unit 104 including an intermediate transfer belt 6. Here, the intermediate transfer belt 6 is disposed so as to be in contact with the respective photosensitive drums 2 and rotates in a direction of an arrow in FIG. 1 by being driven by a driving roller 62 driven by a driving portion not shown. Primary transfer rollers 61 being in contact with the intermediate transfer belt 6 are disposed on an inside side of the intermediate transfer belt 6.

It is noted that a secondary transfer roller 9 composing a secondary transfer portion transferring a full-color image formed on the intermediate transfer belt 6 onto the sheet P is provided at a position facing the driving roller 62 of the intermediate transfer unit 104. Still further, a fixing portion 10 is disposed above the secondary transfer roller 9, and a discharge roller pair 11 is disposed downstream in a sheet conveying direction of the fixing portion 10.

Next, an image forming operation of the laser printer 100 constructed as described above will be described. In response to a start of the image forming operation, the scanner unit 1 irradiates a laser beam based on image information inputted from a personal computer or the like not shown to exposure a surface of the photosensitive drum 2 homogeneously charged with predetermined polarity and potential and to form an electrostatic latent image on the photosensitive drum 2. After that, the electrostatic latent image is developed and visualized by toner. Then, toner images of four colors of yellow (Y), magenta (M), cyan (C), and black (Bk) are transferred onto the intermediate transfer belt 6 by a transfer bias applied to the primary transfer rollers 61 to form a full-color toner image on the intermediate transfer belt 6.

Concurrently with the image forming operation, the sheet P stored in the sheet feed cassette 7 is delivered out by the sheet feeding portion 101. The sheet P is then conveyed to an inactivated registration roller pair 8 to correct a skew thereof. Next, the registration roller pair 8 is driven to convey the sheet P so as to align a front end of the sheet P whose skew has been corrected with a position of the full-color toner image on the intermediate transfer belt 6 in the secondary transfer portion. Then, the full-color toner image is collectively transferred onto the sheet P by a secondary transfer bias applied to the secondary transfer roller 9 in the secondary transfer portion.

Next, the sheet P onto which the full-color toner image has been transferred is conveyed to the fixing portion 10 to fix the toner image on the sheet P as a full-color image by melting and blending the toners of the respective colors by heat and pressure. The sheet P on which the full-color image has been fixed is discharged by the discharge roller pair 11 to a discharge tray 12 provided on an upper surface of the printer body. It is noted that in a case when images are to be formed on both surfaces of the sheet, the discharge roller pair 11 is reversely rotated to convey the sheet P on which the toner image has been fixed to a duplex path R1 and again to the image forming portion 102.

By the way, as shown in FIG. 1, the printer body 100A is provided with a door 103 supported turnably (openably) in a vertical direction at one side surface of the apparatus by a turning shaft 13 provided at a lower end thereof as a fulcrum. The door 103 can be opened in taking out a jammed sheet jammed at the registration roller pair 8 and others and in conducting maintenance of the apparatus.

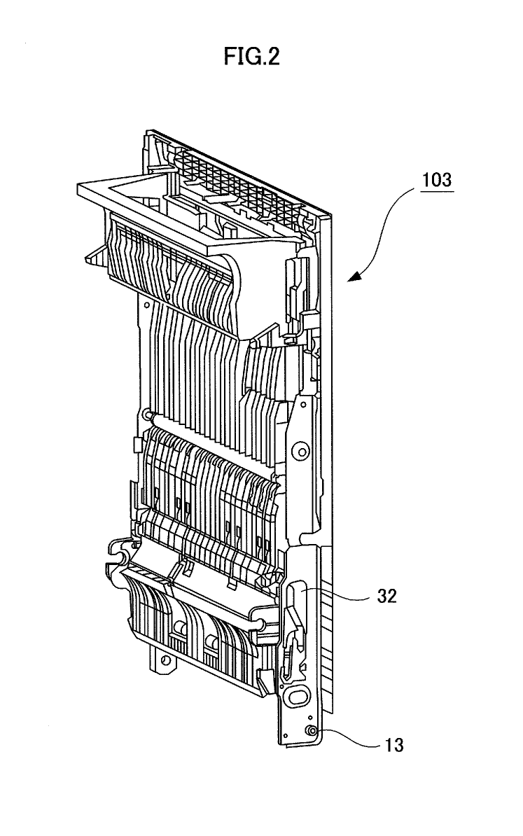

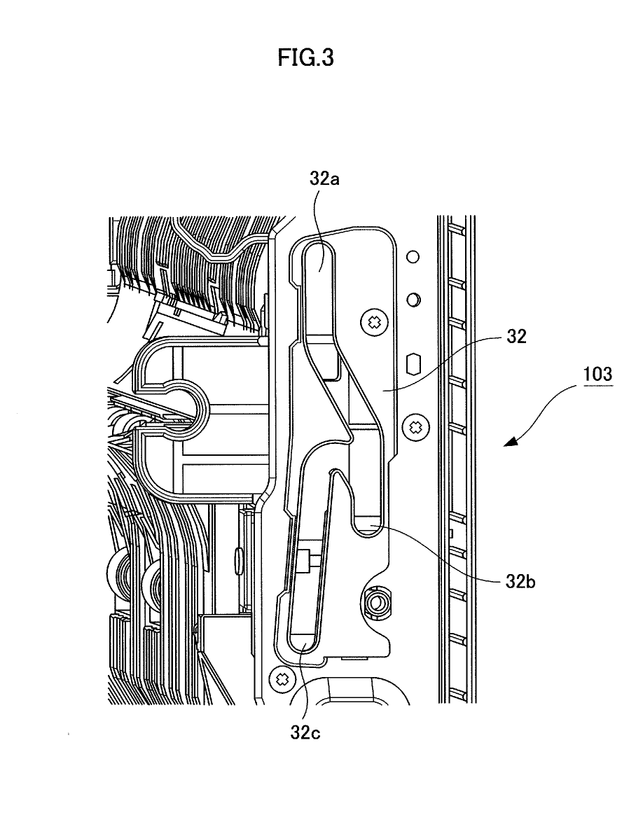

An opening angle of the door 103 is restricted with respect to the printer body 100A by a stopper member 14 provided on a front side of the printer body 100A and turning centering on a turning shaft portion 24 as a fulcrum and a stopper member not shown and provided inside of the front-side stopper member 14 so as to face the front-side stopper member 14. A rail member 32 is provided as shown in FIG. 2 in order to restrict the opening angle by the stopper member 14 as described above. As shown in FIG. 3, the rail member 32 includes a first path 32a, a second path 32b, and a third path 32c branched from a part between the first and second paths 32a and 32b.

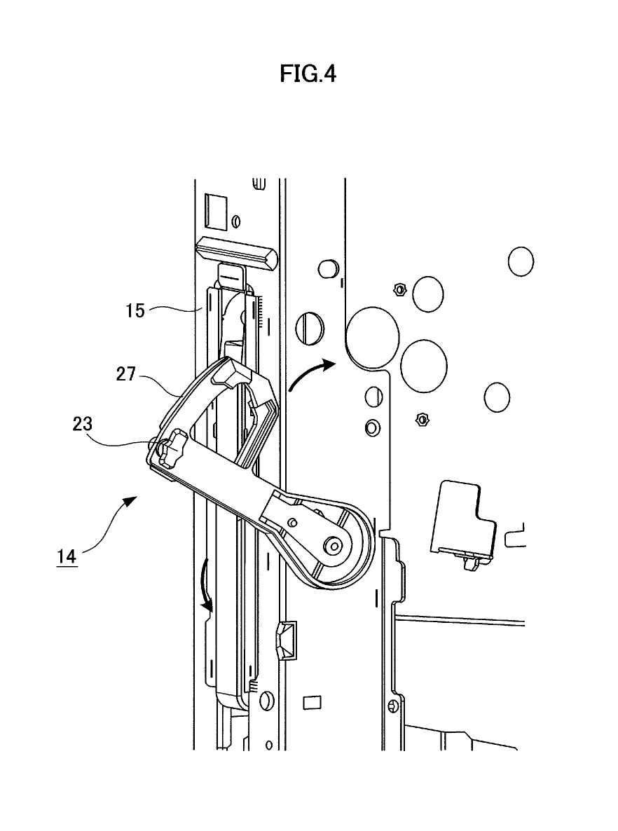

Here, the first, second, and third paths 32a, 32b and 32c are paths where a project portion 23, i.e., a first engage portion, provided at a turning end of a stopper member 14 shown in FIG. 4. It is noted that the stopper member 14, i.e., an arm portion, turnably supported by a body frame 15 centering on a turning shaft portion 24, i.e., a second engage portion, shown in FIG. 1 as a fulcrum includes a grip portion 27 manipulated in entering the project portion 23 into the third path 32c as described later.

Then, when the door 103 is opened, the project portion 23 of the stopper member 14 moves slidingly through the slit-like first path 32a to the second path 32b of the rail member 32 slidably support the project portion 23 and holds the door 103 in an open condition by locking the project portion 23. Here, while the door 103 is opened to remove a jammed sheet, normally the project portion 23 moves from the first path 32a to the second path 32b by own weight of the stopper member 14 when the door 103 is opened to remove the jammed sheet.

Then, the door 103 is held at an opening angle (open position) for handling the jammed sheet by the stopper member 14 whose project portion 23 has moved to the second path 32b. That is, the second path 32b keeps the door 103 at the first opening angle to handle the jammed sheet by means of the stopper member 14. Still further, the project portion 23 enters the first path 32a so that the stopper member 14 does not obstruct the door 103 from being closed.

The door 103 is also opened in maintaining and inspecting the apparatus. In this case, the door 103 is opened at first to the first opening angle, and then an operator places a finger on the grip portion 27 of the stopper member 14 to guide the project portion 23 which has been moved to the second path 32b to the third path 32c. Thereby, the door 103 is opened further to a second opening angle (open position) for maintenance by the stopper member 14 whose project portion 23 has moved to the third path 32c. It is noted that the second opening angle for maintenance is larger than the first opening angle for handling the jammed sheet.

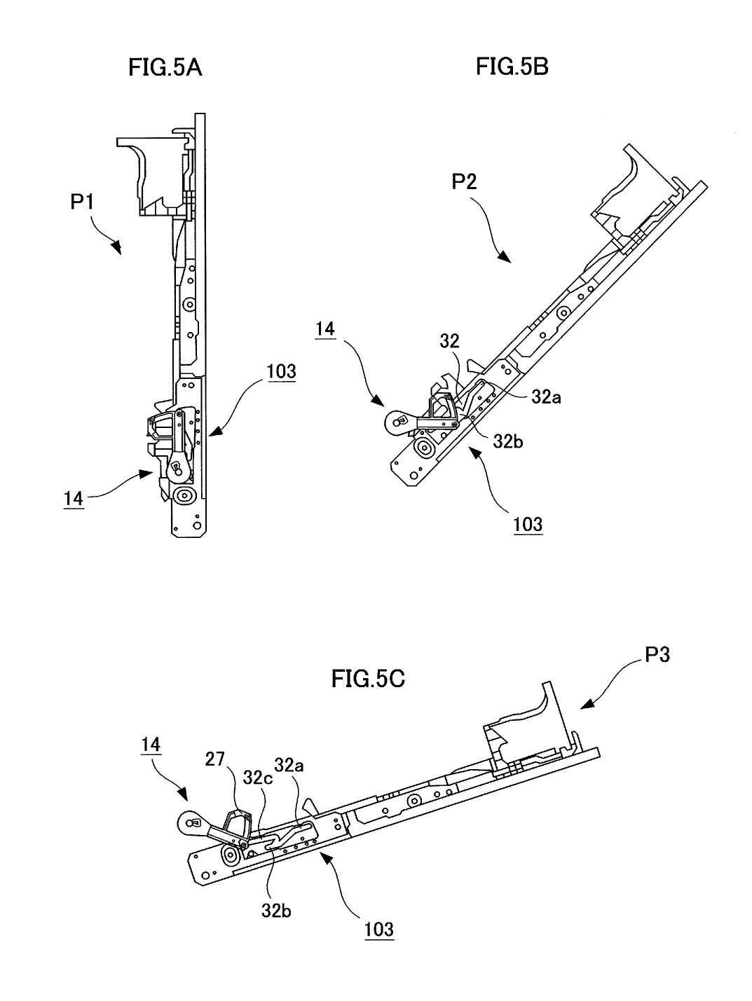

FIGS. 5A through 5C illustrate conditions of the stopper member 14 in opening/closing the door 103. FIG. 5A illustrates a condition when the door 103 is closed (condition P1). At this time, the project portion 23 of the stopper member 14 is located within the first path 32a. FIG. 5B illustrates a condition when the door 103 is opened when jamming has occurred (condition P2). At this time, the project portion 23 of the stopper member 14 is in contact with an inner wall face of one end of the second path 32b. The door 103 is held at the first opening angle for handling the jammed sheet in this condition.

FIG. 5C indicates a condition when the door 103 is opened (condition P3) to attach/detach a unit, a component, or the like within the image forming apparatus or to maintain the apparatus such as cleaning of an inside of the printer body. At this time, the project portion 23 of the stopper member 14 is in contact with an inner wall face of one end of the third path 32c as a result of the manipulation of the grip portion 27. The door 103 is held at the second opening angle in this condition. Thus, it is possible to switch the opening angle (open position) of the door 103 by switching the positions where the project portion 23 of the stopper member 14 is locked in the rail member 32.

By the way, while an operation of opening the door 103 is conducted after releasing a lock mechanism not shown, there is a case when the operator leaves his/her hand on a way of this operation or applies a force in a direction in which the door 103 is opened in moving the condition from the condition P1 shown in FIG. 5A to the condition P2 shown in FIG. 5B. Here, because the door 103 turns centering on the turning shaft 13 provided at the lower end as the fulcrum and if the door 103 is turned, the door 103 turns until when the condition P2 shown in FIG. 5B by its own weight.

Still further, the stopper member 14 is mounted turnably centering on the turning shaft portion 24 as the fulcrum as shown in FIG. 1 and as described above. Therefore, the project portion 23 of the stopper member 14 enters from the first path 32a to the second path 32b along with the turn of the door 103 and then collides against the inner wall face of one end of the second path 32b. When the project portion 23 collides against the end of the second path 32b as described above, a large impact force is applied to the stopper member 14 and the body frame 15 and others supporting the stopper member 14, so that the stopper member 14 or components of the body frame 15 and others are possibly deformed or broken.

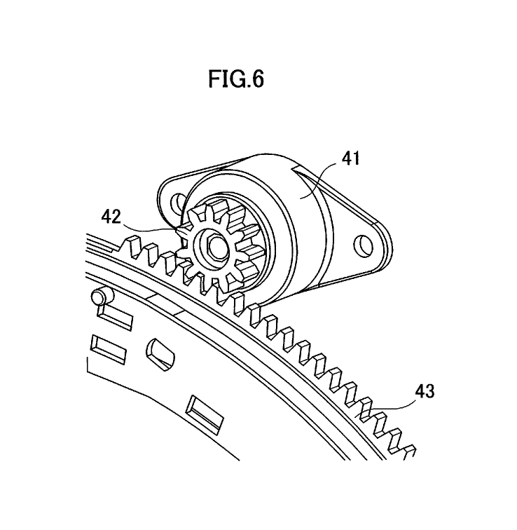

Therefore, according to the present embodiment, the printer body 100A is provided with a damper mechanism as shown in FIG. 6 in order to relieve such impact force. That is, FIG. 6 shows a rotary damper 41 provided on a frame not shown of the printer body 100A. The rotary damper 41 includes a rack 43 provided on the door 103 and a pinion 42 engaging with the rack 43. The pinion 42 and the rack 43 relieve the impact force by retarding a turning speed of the door 103 by engaging with each other and applying a load in a turning direction of the door 103.

By the way, in setting a torque value of the rotary damper 41 relieving the impact force, it is necessary to increase the torque value of the rotary damper 41 to avoid deformation and break of the related components if an assumed value of the impact force is large. However, if the torque value of the rotary damper 41 is large, a rotary load generated by the rotary damper 41 becomes resistance to an operating force for opening/closing the door 103 and drops the operability. Still further, because there is a case when the door 103 stands still between the conditions P1 and P2 as described above and as shown in FIGS. 5A through 5C if the operator leaves his/her hands from the door on the way of opening the door 103, the operator is required to add an extra force in the opening direction of the door 103.

Still further, if the assumed value of the impact force is set to be too small in contrary, there is a case when the stopper member 14 itself and the components such as the body frame 15 are deformed or are broken. Then, assuming that a total weight of the door 103 is about 4 kg and the opening angle when the door 103 is in the condition P2 is 45°, an arrangement in which about 80 N is applied to the stopper members 14 (about 40 N on each) located on the front and rear sides of the printer body 100A when the door 103 stands still in the condition P2 is adopted in the present embodiment.

It is noted that in a case when the lock is released in a state in which there is no damper mechanism and the door 103 is freely fallen in the opening direction, a force applied to the stopper members 14 is about 200 N (100 N on each). Under such condition, a maximum value of the impact force applied to the stopper members 14 when the user vigorously opens the door 103 is assumed to be 1000 N which is five times of the impact force of the free fall in the present embodiment.

In light of the condition described above, the stopper member 14 is constructed by a material having such strength by which the front and rear side stopper member 14 are not broken even if the impact force of 1000 N (500 N on each) in total is applied to the stopper members 14. Actually, a material having strength that sustains the impact force of about 600 N on each is adopted for the stopper member 14.

Still further, the rotary damper 41 used is configured such that a resistance load of 50 to 70 N is applied to the opening operation of the door 103 by the damping function in a range from a middle of the moving path of the conditions P1 to P2 to the position of the condition P2. The use of such rotary damper 41 makes it possible to minimize the deformation or the like of the peripheral components and to steadily put the door 103 into the condition P2 without standing still on the way when the door 103 is freely fallen.

However, even if the stopper member 14 and the rotary damper 41 constructed as described above are used, there is a case when the stopper member 14 deforms or breaks if an impact force of more than estimation is applied to the stopper member 14 through the door 103 in opening the door 103. Then, although it may be possible to prevent the stopper member 14 from being broken if the stopper member 14 is made of a material of higher strength, there is a case when the body frame 15 to which the stopper member 14 is mounted or part of the door 103 is broken

Then, the stopper member 14 is configured so as to prevent the entire stopper member 14, the door 103, and others from being broken when the stopper member 14 is pulled by the impact force of more than estimation applied through the door 103 by arranging such that just a part of the stopper member 14 is broken in the present embodiment.

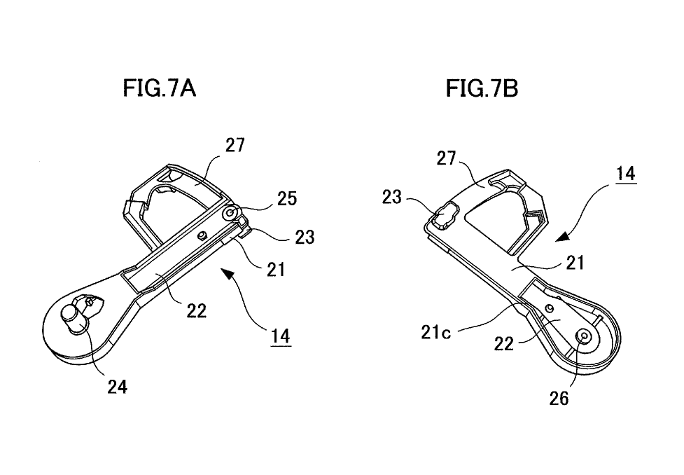

FIGS. 7A and 7B are perspective views illustrating the configuration of the stopper member 14 of the present embodiment. FIG. 7A is a perspective view of the stopper member 14 and FIG. 7B is a perspective view of the stopper member 14 viewed from a different direction from that of FIG. 7A.

In FIG. 7, the stopper member 14 includes a base member 21 made of a resin material composing a body portion of the stopper member 14, a turning shaft portion 24 formed at one end part of the base member 21, the project portion 23 formed on another side of the base member 21, a reinforcing member 22 made of a metallic material and attached to the base member 21 so as to reinforce the base member 21, first and second screws 25 and 26, i.e., shaft-like members, joining the base member 21 with the reinforcing member 22.

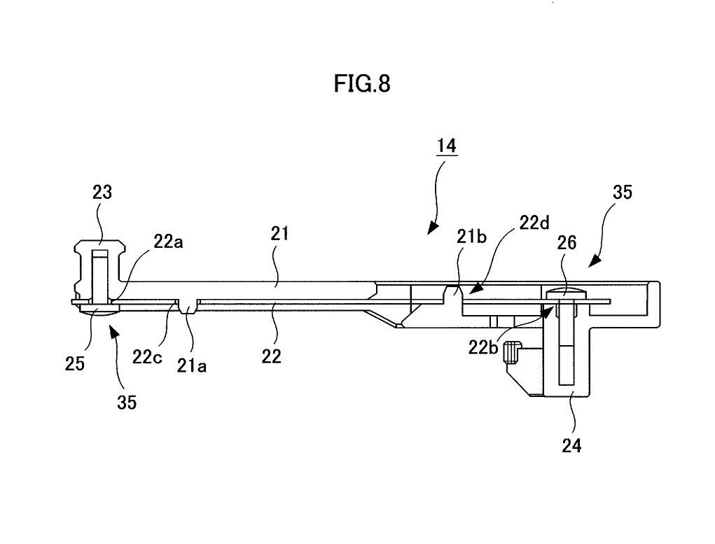

It is noted that positions where the base member 21 is jointed with the reinforcing member 22 by the first and second screws 25 and 26 are set such that the first screw 25 enters the project portion 23 and the second screw 26 enters the turning shaft portion 24 in the present embodiment as shown in FIG. 8. It is then possible to enhance strength sustaining the project portion 23 and the turning shaft portion 24 from breakage by joining the base member 21 with the reinforcing member 22 by inserting the first screw 25 into the project portion 23 and the second screw 26 into the turning shaft portion 24. That is, the project portion 23 is reinforced by the first screw 25 and the turning shaft portion 24 is reinforced by the second screw 26, respectively.

Still further, as shown in FIG. 8, the reinforcing member 22 is provided with a first insertion hole 22a through which the first screw 25, i.e., the first shaft-like member, enters the project portion 23 and a second insertion hole 22b through which the second screw 26, i.e., the second shaft-like member, enters the turning shaft portion 24. Thus, a joining mechanism 35 joining the reinforcing member 22 with the base member 21 is composed of the first screw 25 and the first insertion hole 22a and the second screw 26 and the second insertion hole 22b.

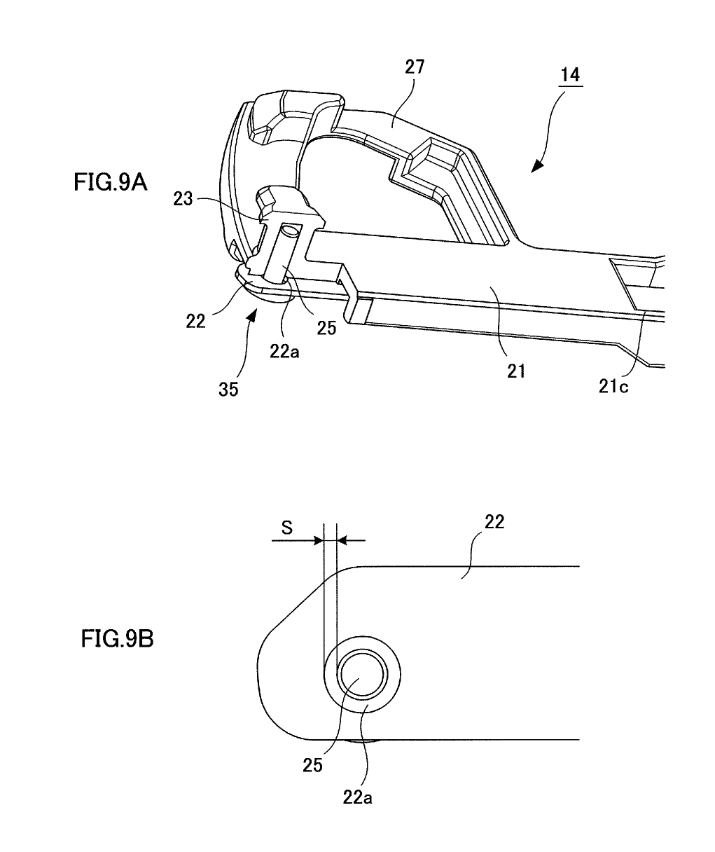

It is noted that the reinforcing member 22 is also provided with a third insertion hole 22c as shown in FIG. 8. A convex portion 21a formed on the base member 21 is locked by the third insertion hole 22c with a gap similar to a gap S shown in FIG. 9B and described later. The reinforcing member 22 is also provided with a fourth insertion hole 22d through which a convex portion 21b formed on the base member 21 is locked without forming any gap.

Here, a diameter of the first insertion hole 22a through which the first screw 25 enters the project portion 23 as shown in FIG. 9A is a diameter forming the gap S in a radial direction as shown in FIG. 9B in a state in which the first screw 25 enters the first insertion hole 22a.

It is noted that this gap S is set at a maximum range or more in which the base member 21 extends by tensile force applied to the base member 21 by impact in the present embodiment. Still further, a diameter of the second insertion hole 22b through which the second screw 26 enters the turning shaft portion 24 is a diameter forming no gap in a state in which the second screw 26 enters the second insertion hole 22b.

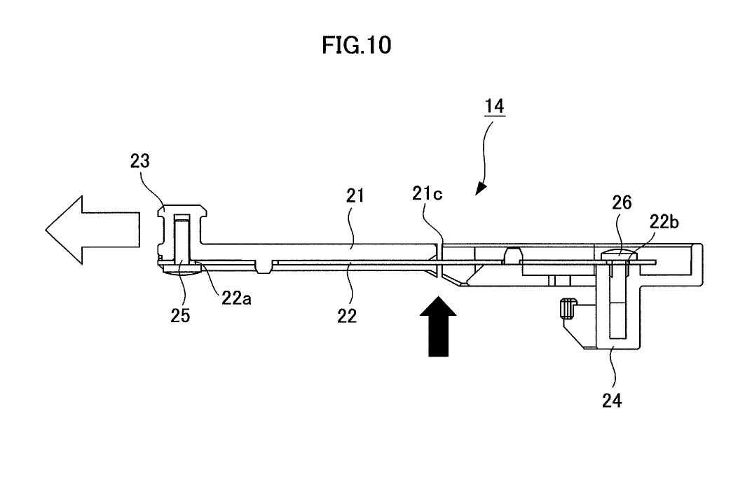

There is a case when an impact force of more than estimation, i.e., a force larger than tensile strength of the base member 21, is applied to the stopper member 14 constructed as described above in a direction of a white arrow (in a longitudinal direction of the arm portion) shown in FIG. 10 when a force more than a predetermined magnitude is applied to the door 103 in opening the door 103. In this case, the impact force is applied to the project portion 23 and the turning shaft portion 24 of the stopper member 14, and the tensile force acts on the second screw 26 entering an inside of the turning shaft portion 24 and the first screw 25 entering an inside of the project portion 23.

At this time, the second screw 26 entering the inside of the turning shaft portion 24 does not move because no gap is provided between the second screw 26 and the second insertion hole 22b. However, the first screw 25 entering the inside of the project portion 23 is capable of moving along the first insertion hole 22a because the gap S is provided between the first screw 25 and the first insertion hole 22a. Therefore, when such force is applied to the project portion 23, the base member 21 elastically deforms while moving the first screw 25 along the first insertion hole 22a.

However, because the gap S is set at the maximum range of the base member 21 extending by the elastic deformation or at a breakdown distance longer than that as described above, the elastically deformed base member 21 breaks (fractures) at a position indicated by a black arrow. It is noted that the base member is provided with a fracture portion 21c formed such that strength thereof is lower than that of other parts of the base member 21 at the position indicated by the black arrow where stress concentration is generated between the project portion (first engage portion) 23 and the rotary shaft portion (second engage portion) 24. The fracture portion 21c is formed to break down first when a stress of more than a predetermined magnitude is generated in the base member 21. The fracture portion 21c is constructed by providing an opening in a groove portion of the base member 21 holding the reinforcing member 22 in the present embodiment. It is noted that the fracture portion 21c may be constructed by providing, other than the opening (hole), a crack, a groove, a step, or the like on the base member 21. It is then possible to absorb the impact force by thus breaking the base member 21. That is, the base member 21 is joined with the reinforcing member 22 such that the base member 21 is pulled and is broken in the case when a force of predetermined magnitude is applied to the door 103 in opening the door 103.

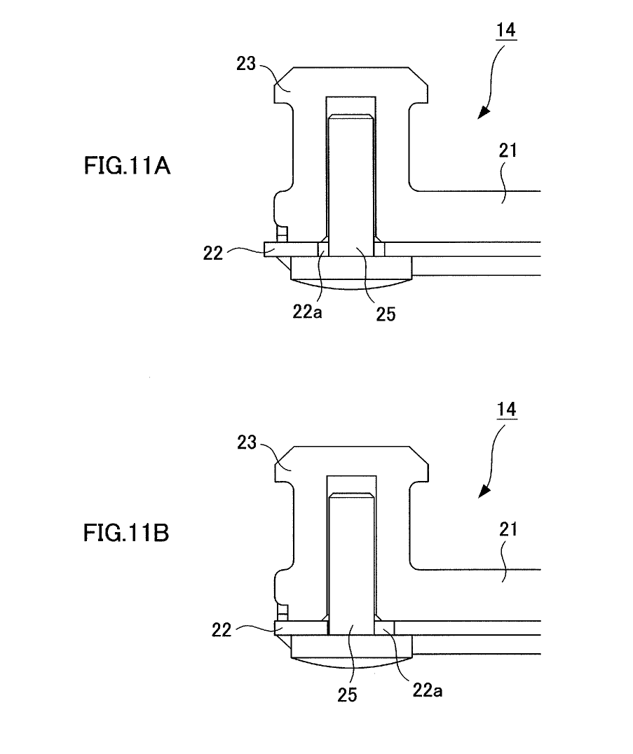

It is noted that if the base member 21 is broken, the base member 21 moves in a body with the first screw 25 from a position shown in FIG. 11A to a position where the first screw 25 engages with one inner wall face of the first insertion hole 22a of the reinforcing member 22 as shown in FIG. 11B. Then, after that, the first screw 25 engages with the first insertion hole 22a of the reinforcing member 22, and thereby, the project portion 23 is limited from moving by the reinforcing member 22. As a result, it is possible to prevent the project portion 23 from disengaging from the door 103 and to prevent the door 103 from falling down to a floor.

As described above, the gap S is provided between the first insertion hole 22a and the first screw 25, and in the case when an impact force of more than estimation is applied, the base member 21 is configured to be broken and the door 103 is held by the reinforcing member 22 in the present embodiment. This arrangement makes it possible to prevent the entire stopper member 14 from being broken and to prevent the door 103 from falling down. That is, in the case when the force of more than the predetermined magnitude is applied to the door 103 in opening the door 103, it is possible to prevent the door and the body of the image forming apparatus from being broken in opening the door without lowering the operability by joining the reinforcing member with the body portion of the stopper member 14 such that the body portion is pulled and is broken. It is noted that in the case when the base member 21 is broken, it is possible to handle such case only by replacing the stopper member 14 and to avoid such situation that the door 103 and the body frame 15, i.e., large size units, are deformed or replaced.

That is, the base member 21 is joined with the reinforcing member 22 such that the base member 21 is broken and the door 103 is held by the reinforcing member 22 when the force of more than the predetermined magnitude is applied to the project portion 23 in opening the door in the present embodiment. This arrangement makes it possible to prevent the entire stopper member 14, the door 103 in opening the door 103, and the printer body 100A from being broken without lowering the operability.

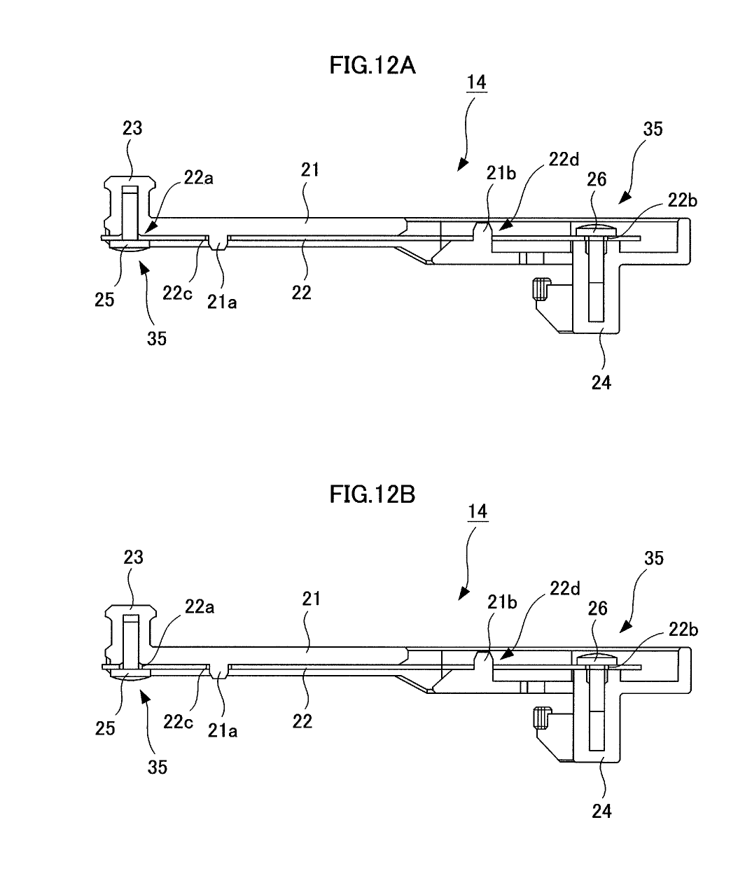

It is noted that while the gap S is provided between the first insertion hole 22a and the first screw 25 in the description described above, it is also possible to provide a gap between the second insertion hole 22b and the second screw 26 as shown in FIG. 12A. Still further, the gap may be provided between the first insertion hole 22a and the first screw 25 as well as between the second insertion hole 22b and the second screw 26. That is, the same operation may be obtained by providing the gap S at least at either between the first insertion hole 22a and the first screw 25 or between the second insertion hole 22b and the second screw 26.

Still further, while the base member 21 of the stopper member 14 has been a resin-made member and the reinforcing member 22 has been a metallic member in the embodiment described above, the materials of those components are not specifically limited. For instance, the base member 21 may be a rubber material, and the reinforcing member 22 may be a resin material. However, if a material such as metal whose strength is high is used for the base member 21, it is preferable to provide apart partially constricted for example such that the part breaks if an impact force of more than estimation is applied. It is also possible to configure such that the base member 21 is composed of a plurality of members and that the members are broken in order corresponding to an impact force.

Still further, although the screws are used as the shaft-like members joining the base member 21 with the reinforcing member 22 in the present embodiment, the present invention is not specifically limited to such configuration. For instance, it is possible to obtain the same effect by configuring such that a metallic pin inserted or hooked into a hole provided through the reinforcing member 22 is secured by means of press fitting. Still further, while the door 103 has the two open positions in the embodiment described above, a number of open positions may be one or three or more.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-203685, filed Oct. 2, 2014, which is hereby incorporated by reference herein in its entirety.

What is claimed is:

1. An image forming apparatus, comprising:
an apparatus body;
a door openably supported by the apparatus body; and
an arm portion whose one end is supported by the apparatus body and locking and holding the door in an open condition, the arm portion including:
a body portion including a first engage portion engaging with the door and a second engage portion engaging with the apparatus body; and
a reinforcing member locking the door when the body portion is broken by force applied to the door in opening the door.

2. The image forming apparatus according to claim 1, further comprising a joining mechanism joining the reinforcing member with the body portion such that, in response to the breakage of the body portion by the force applied to the door in opening the door, the reinforcing member supports the first and second engage portions of the broken body portion.

3. The image forming apparatus according to claim 2, further comprising:
a shaft-like member joining the body portion with the reinforcing member;
an insertion hole provided through the reinforcing member and through which the shaft-like member is inserted in a condition in which a gap is provided between the insertion hole and the shaft-like member.

4. The image forming apparatus according to claim 2, wherein the joining mechanism includes:
first and second shaft-like members joining the reinforcing member with the body portion;
a first insertion hole provided at one end part of the reinforcing member and through which the first shaft-like member is inserted; and
a second insertion hole provided at another end part of the reinforcing member and through which the second shaft-like member is inserted,
wherein the first and second shaft-like members are inserted into the first and second insertion holes such that at least one of the first and second insertion holes is provided with a gap between the first shaft-like member or between the second shaft-like member.

5. The image forming apparatus according to claim 4, wherein the first shaft-like member joins the reinforcing member with the body portion by entering an inside of the first engage portion and the second shaft-like member joins the reinforcing member with the body portion by entering an inside of the second engage portion.

6. The image forming apparatus according to claim 1, wherein the body portion is a resin-made member and the reinforcing member is a metallic member.

7. The image forming apparatus according to claim 1, wherein the first engage portion is a projection slidably supported by the door and the second engage portion is a shaft portion turnably supported by the apparatus body.

8. An image forming apparatus, comprising:
an apparatus body;
a door openably supported by the apparatus body;
a stopper member including a first engage portion engaging with the apparatus body and a second engage portion engaging with the door, and holding the door in an open condition;
a first shaft-like member inserted into the first engage portion of the stopper member;
a second shaft-like member inserted into the second engage portion of the stopper member; and
a metal member through which the first shaft-like member inserted into the first engage portion of the stopper member and the second shaft-like member inserted into the second engage portion of the stopper member are inserted.

9. The image forming apparatus according to claim 8, wherein the metal member is provided with first and second insertion holes through which the first and second shaft-like members are respectively inserted, and
wherein at least one of the first and second insertion holes is provided with a gap between the first shaft-like member or between the second shaft-like member.

10. The image forming apparatus according to claim 8, wherein the first and second engage portions are projections engaging with the apparatus body and the door.
